(19) United States
(12) Patent Application Publication
(10) Pub. No.: US 2026/0305578 A1
(43) Pub. Date: Oct. 8, 2026

(54) MULTI-CHANNEL WALK-IN FLOOR-REARED POULTRY GROWTH PERFORMANCE MEASUREMENT SYSTEM AND METHOD

(71) Applicants: South China Agricultural University, Guangzhou (CN); Guangdong Laboratory for Lingnan Modern Agriculture Science and Technology, Guangzhou (CN); Guangzhou Huanong University Smart Agriculture Technology Co., Ltd., Guangzhou (CN)

(72) Inventors: Deqin Xiao, Guangzhou (CN); Shaohai Peng, Guangzhou (CN); Dakang Guo, Guangzhou (CN); Zhuoheng Tang, Guangzhou (CN); Lei Cheng, Guangzhou (CN); Zeyuan Lin, Guangzhou (CN); Weichao Lin, Guangzhou (CN); Yuanyang Mao, Guangzhou (CN); Jiatao Wang, Guangzhou (CN); Handong Wang, Guangzhou (CN); Weiming Liu, Guangzhou (CN); Ruofei Tan, Guangzhou (CN)

(21) Appl. No.: 19/296,115

(22) Filed: Aug. 11, 2025

(30) Foreign Application Priority Data
Apr. 8, 2025 (CN) 202510431786.0

(51) Int. Cl. A01K 29/00; A01K 31/18; A01K 35/00; G01G 3/142; G01G 17/08; G01S 1/68

(52) U.S. Cl. CPC A01K 29/002; A01K 29/005; A01K 31/18; A01K 35/00; G01G 3/142; G01G 17/08; G01S 1/68

(57) ABSTRACT

A multi-channel walk-in floor-reared poultry growth performance measurement method utilizes a walk-in, multi-channel growth performance measurement device based on behavioral characteristics. This design adapts to different scales of poultry farming, allowing for flexible expansion and deployment. Through a signal calibration matching strategy, the RFID signals from various channels are accurately matched with strain gauge sensor data; this ensures that signals between different channels do not interfere, enabling error-free individual information identification. By using RFID technology to record poultry's activity frequency and dwell time in different areas, we can analyze their activity distribution patterns; this provides data support for further behavioral research and health status monitoring, offering a large amount of effective data for screening superior poultry; furthermore, this system achieves unmanned automated monitoring for the farm, improving poultry farm production efficiency and reducing flock stress caused by manual operations, guaranteeing the standardization and reliability of data collection.

### 1. TECHNICAL FIELD

The invention relates to the field of poultry farming, and in particular to a multi-channel walk-in floor-reared poultry growth performance measurement system and method.

### 2. BACKGROUND ART

Currently, poultry farming models are primarily divided into two types: cage rearing and floor rearing. Compared with cage rearing, animals in floor rearing experience less stress and better conform to animal welfare standards. Among floor-reared poultry, individual growth performance is a crucial physiological parameter monitored during the rearing process. Real-time monitoring of individual growth performance in large flocks of floor-reared poultry can reflect their growth status and welfare, while also allowing for timely identification and removal of poultry with abnormal weights.

Currently, poultry farms mainly use traditional manual static weighing to measure live weight. Although manual weighing provides relatively accurate live weight measurements, it is challenging to operate for large poultry flocks, requiring significant labor and time to measure each poultry individually. Furthermore, this method involves a long time span for measurement, making it difficult to achieve real-time monitoring of the poultry flock. Additionally, manual weighing can easily cause stress to the poultry, which reduces their production efficiency.

To address the above problems, researchers are currently exploring different technologies to obtain live animal weights without causing stress. Existing techniques include using 3D vision technology to estimate pig weights. This involves acquiring images of pigs with an RGBD (Red Green Blue Depth) camera, building a 3D model from the 3D point cloud, and then using a weight estimation model to determine the pig's weight. While this method saves time and effort and avoids stress, it's challenging to accurately create 3D models for smaller poultry, and the presence of feathers makes precise weight estimation difficult for the poultry. Another approach is a perch-style device that leverages the roosting habits of poultry. This device automatically measures weight when poultry perch on it. However, this method only works for poultry that are willing to perch, making it difficult to measure large flocks, especially waterfowl like geese, which don't have this roosting habit.

### 3. SUMMARY OF THE INVENTION

In view of the above deficiencies in the prior art, the invention provides a multi-channel walk-in floor-reared poultry growth performance measurement method.

In order to achieve the object of the invention, the invention adopts the following technical solution:
a multi-channel walk-in floor-reared poultry growth performance measurement system, comprising a control processing module, a position information module, a behavior analysis module, a weight calculation module, and a result storage module,
the position information module unidirectionally transmits poultry position information to the control processing module, the control processing module processes data to obtain position information of the poultry; the control processing module then sends an instruction to activate the weight calculation module, the weight calculation module collects dynamic weight of the poultry passing through the channel and calculates true weight of the poultry before returning it to the control processing module; the control processing module obtains behavior type of the poultry from the collected information via the behavior analysis module, finally, based on the obtained dynamic weight and behavior characteristics of the poultry, predicted weight of the poultry is analyzed, and the data is transmitted to the result storage module for saving.

A multi-channel walk-in floor-reared poultry growth performance measurement method, comprising the following steps;
S1: building a multi-channel walk-in floor-reared poultry growth performance measurement device, comprising a ramp, an RFID (Radio Frequency Identification) reader/writer, a channel platform, a bottom resistive strain gauge sensor, channel railings, an RFID reader/writer, a system host, a multi-function weighing and force measuring instrument, a system display screen, a console-type operating enclosure platform, and channel baffles;
S2: when the poultry steps onto the channel platform, the weight calculation module activates, at this point, the resistive strain gauge sensor at a bottom of the channel platform begins to operate, continuously reading weight information of the poultry, the weight reading process is completed when the weight returns below a threshold;
S3: calculating the true weight of the poultry from the collected weight information, the specific method is as follows: S31: calculating expected value of overall dynamic weight data from the continuously read poultry weight information obtained in S2;
S32: determining if the dynamic weight is stable based on the expected value calculated in S31, if not stable, filtering out abnormally fluctuating body weight values by using a median filtering algorithm;
S33: performing mean filtering on median-filtered weight values to reduce overall dynamic weight fluctuations;
S34: based on processing results from S33, inputting processed data into the weight calculation module for weight calculation and outputting weight calculation results;
S35: dividing the weight calculation results output from S34 into multiple data slices, and calculating slope, intercept, and root mean square error for each group of data;
S36: repeating S31-S35 until there are no further data groups, then the weight calculation is completed, and an optimal predicted weight is output as the true weight of the poultry.

Further, a calculation method for the expected value in S32 is as follows:

$$E = \frac{1}{n - 1} {{\sum }_{i = 1}}^{n - 1} \vert {w}_{i + 1} - {w}_{i} \vert$$

wherein E represents the expected value of dynamic weight curve, n represents the number of weight data collected, wᵢ represents true weight value.

Further, a specific method for the median filtering in S32 is as follows:

$$\text{?} = median ( {w}_{i - m} , {w}_{i - m + 1} , … , {w}_{i + m} )$$

wherein i represents time, [symbol] represents predicted weight value, wᵢ represents true weight value, m represents a window size of the median filtering, median ( ) represents a calculation of median for a set of data.

Further, a specific method for the mean filtering in S33 is as follows:

$${\hat{w}}_{i} = \frac{1}{2 m + 1} {\sum }_{k = i - m}^{i + m} {w}_{k}$$

wherein i represents time, [symbol] represents predicted weight value, k represents a position of weight data within the filtering window, wₖ represents weight value before mean filtering, m is a window size of the mean filtering.

Further, a specific method for the root mean square error in S35 is as follows:

$$RMSE = \sqrt{\frac{1}{M} {\sum }_{i = 1}^{M} {( {\hat{w}}_{i} - {w}_{i} )}^{2}}$$

wherein i represents time, [symbol] represents predicted weight value, wᵢ represents true weight value, M represents the number of samples used to calculate the root mean square error.

Further, S4 specifically comprises the following steps:
S41: after the poultry passes through the channel, information collected by the RFID reader/writer is transmitted to the position information module, the information is then sorted by the order of collection time;
S42: after preprocessing the data, RFID antenna numbers from which signals were read before and after the poultry passed through the channel are compared to determine if the poultry has indeed gone through that channel;
S43: based on the RFID antenna numbers where identity information was read (before and after), direction of entry/exit of the poultry is determined; according to the currently read RFID antenna position of the poultry and the entry/exit direction, current location information of the poultry is determined;
S44: by comparing relevant data (collected time, weight, and reading position) during different time periods, a distribution pattern of the poultry is obtained.

The invention has following advantageous effects:
(1) designed with a detachable, modular walk-in multi-channel system, it adapts to various poultry flock sizes, offering excellent flexibility and scalability;
(2) achieves 24-hour real-time automated monitoring, reducing manual intervention and saving significant labor and time costs; this also minimizes stress on poultry from manual operation;
(3) combines low-cost chips with RFID antennas, drastically cutting costs while accurately reading poultry identity and location information;
(4) conducts big data statistics on individual poultry, automatically collecting multi-dimensional data including individual growth performance, behavioral characteristics, and location distribution; this ensures comprehensive information gathering and provides accurate, reliable data support;
(5) the data system platform can analyze various collected data in real time and quickly report anomalies, aiding in timely management decisions and improving farming efficiency.

### 4. BRIEF DESCRIPTION OF ACCOMPANYING DRAWINGS

FIG. 1 is a three-dimensional schematic diagram of the complete structure of the invention.

FIG. 2 is a three-dimensional schematic diagram of the complete channel of the invention.

FIG. 3 is a control logic diagram of the device of the invention.

FIG. 4 is a flow chart of the device implementation of the invention.

FIG. 5 is a flow chart of the weight calculation of the invention.

FIG. 6 is a flow chart of the poultry position analysis of the invention.

### 5. SPECIFIC EMBODIMENT OF THE INVENTION

The specific embodiments of the invention are described below, so that those skilled in the art can understand the invention. However, it should be clear that the invention is not limited to the scope of the specific embodiments. For those of ordinary skill in the art, as long as various changes are within the spirit and scope of the invention as defined and determined by the attached claims, these changes are obvious, and all inventions and creations utilizing the concept of the invention are protected.

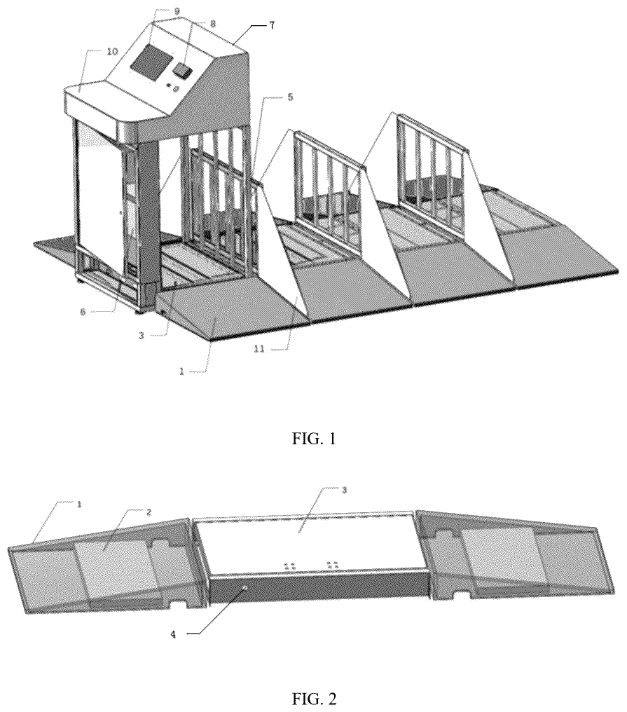

As shown in FIG. 1-FIG. 2, they are respectively a schematic diagram of the specific structure of the device of the invention. In the figure, the device is composed of a ramp 1, an RFID reader/writer 2, a channel platform 3, a bottom resistive strain gauge sensor 4 (its installation position is shown in the figure, located on a bottom back of the channel platform), channel railings 5, an RFID reader/writer 6, a system host 7, a multi-function weighing and force measuring instrument 8, a system display screen 9, a console-type operating enclosure platform 10, and channel baffles 11, etc.

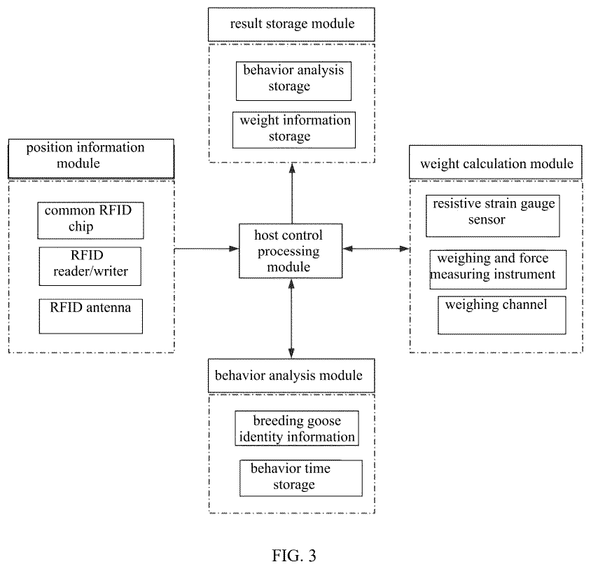

As shown in FIG. 3, this is a control logic diagram of the device of the invention. The device can be divided into five modules, with the host control processing module at its core. The position information module unidirectionally transmits poultry position information to the host control processing module, the control processing module processes data to obtain position information of the poultry; the control processing module then sends an instruction to activate the weight calculation module, the weight calculation module collects dynamic weight of the poultry passing through the channel and calculates true weight of the poultry before returning it to the host control processing module; the host control processing module obtains behavior type of the poultry from the collected information via the behavior analysis module, finally, based on the obtained dynamic weight and behavior characteristics of the poultry, predicted weight of the poultry is analyzed, and the data is transmitted to the result storage module for saving.

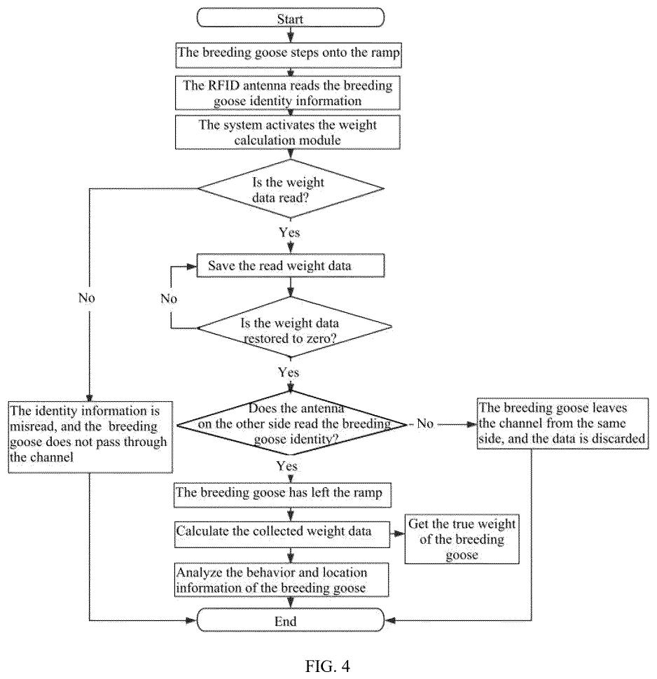

As shown in FIG. 4-FIG. 6, these are the detailed implementation flowcharts of the invention.

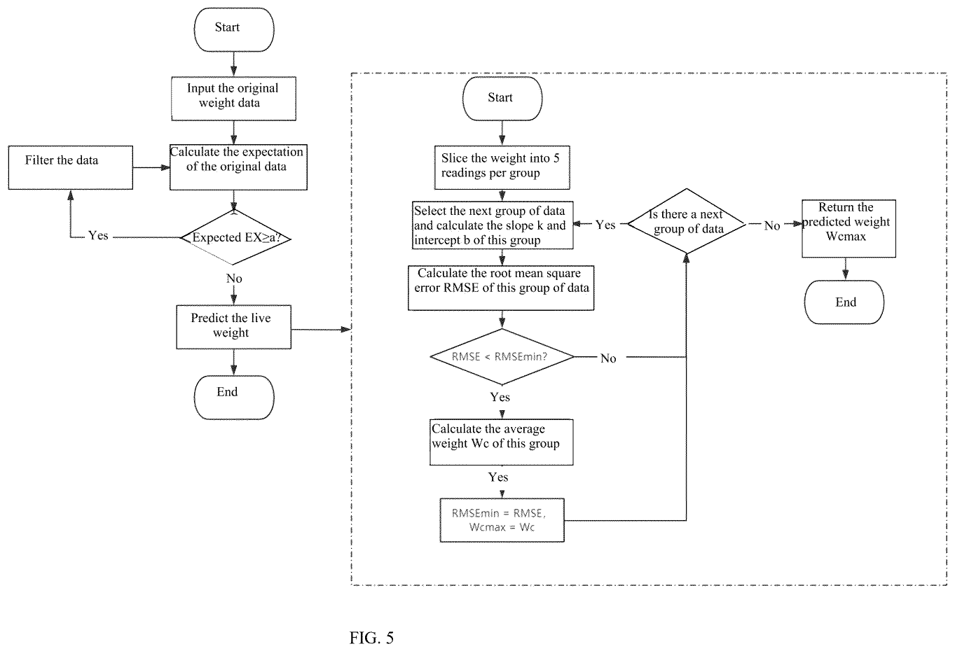

As shown in FIG. 4, this illustrates all the status processes when the poultry passes through the platform. The specific steps are as follows:
S1: when the poultry steps onto the channel platform, the RFID antenna installed at a bottom of the ramp continuously reads identity information of the poultry, and transmits this information along with the time to the host control processing module.
S2: when the poultry steps onto the channel platform, the weight calculation module activates, at this point, the resistive strain gauge sensor at a bottom of the channel platform begins to operate, continuously reading weight information of the poultry, the weight reading process is completed when the weight returns below a threshold.
S3: calculating the true weight of the poultry from the collected weight information; as shown in FIG. 5, the specific method is as follows:
S31: calculating expected value of overall dynamic weight data from the continuously read poultry weight information obtained in S2;
S32: the expected value of the overall dynamic weight data is calculated by using the expected value formula:

$$E = \frac{1}{n - 1} {{\sum }_{i = 1}}^{n - 1} \vert {w}_{i + 1} - {w}_{i} \vert$$

wherein E represents the expected value of dynamic weight curve, n represents the number of weight data collected, wᵢ represents true weight value.
S33: performing mean filtering on median-filtered weight values to reduce overall dynamic weight fluctuations;

Determining if the dynamic weight is stable based on the expected value calculated, filtering the dynamic weight: firstly, filtering out abnormally fluctuating body weight values by using a median filtering algorithm to reduce the extreme range of the curve, wherein the median filtering calculation formula is as follows:

$$\text{?} = median ( {w}_{i - m} , {w}_{i - m + 1} , … , {w}_{i + m} )$$

wherein E represents the expected value of dynamic weight curve, n represents the number of weight data collected, wᵢ₊₁ and wᵢ respectively represent true weight values at time i+1 and time i.

After applying the median filtering algorithm, a mean filtering algorithm is performed once more to reduce the overall dynamic weight fluctuations, making the accuracy of the subsequent weight calculation higher. The mean filtering calculation formula is as follows:

$${\hat{w}}_{i} = \frac{1}{2 m + 1} {\sum }_{k = i - m}^{i + m} {w}_{k}$$

wherein i represents a position of weight data currently being processed, ŵᵢ represents filtered weight value, k represents a position of weight data within the filtering window, wₖ represents weight value before mean filtering, m is a window size of the mean filtering.
S34: after preprocessing the data, inputting the processed data into the weight calculation module for weight calculation.
S35: slicing data into groups of five data points, and calculating slope k, intercept b, and root mean square error for each group of data; the root mean square error calculation formula is as follows:

$$RMSE = \sqrt{\frac{1}{M} {\sum }_{i = 1}^{M} {( {\hat{w}}_{i} - {w}_{i} )}^{2}}$$

wherein i represents time, [symbol] represents predicted weight value, wᵢ represents true weight value, M represents the number of samples used to calculate the root mean square error.
S36: repeating the step until there are no further data groups, then the weight calculation is completed, and an optimal predicted weight is output as the true weight of the poultry.
S4: calculating the distribution location of the poultry based on the read poultry identity information.

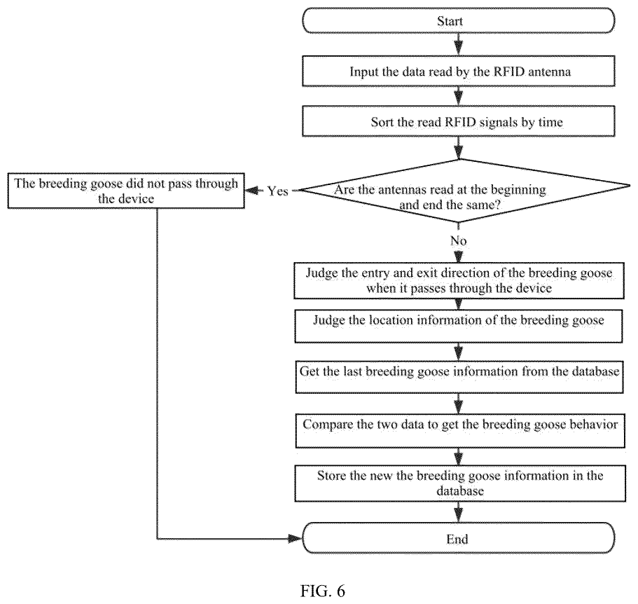

As shown in FIG. 6, this illustrates a process of determining the poultry's distribution location. The poultry's distribution location determination process is as follows:
S41: after the poultry passes through the channel, information collected by the RFID reader/writer is transmitted to the position information module, the information is then sorted by the order of collection time;
S42: after preprocessing the data, RFID antenna numbers from which signals were read before and after the poultry passed through the channel are compared to determine if the poultry has indeed gone through that channel;
S43: based on the RFID antenna numbers where identity information was read (before and after), direction of entry/exit of the poultry is determined; according to the currently read RFID antenna position of the poultry and the entry/exit direction, current location information of the poultry is determined;
S44: by comparing relevant data (collected time, weight, and reading position) during different time periods, a distribution pattern of the poultry is obtained.

This method performs data re-cleaning, preprocessing, and analysis on the behavior data collected in the above steps. This can reduce the impact of data interference and greatly improve the accuracy of individual poultry growth performance analysis; at the same time, by using the collected poultry location, weight, and other information, big data analysis is conducted on the poultry's distribution patterns and growth performance patterns. The specific steps for pattern analysis are as follows.

To study individual poultry growth patterns, we first get the daily live weight data collected in S3. We then calculate the most accurate daily live weight for each poultry based on their behavioral characteristics and different location information, using weeks and months as time units. We then plot the live weight change curve for each poultry. The average live weight change for the entire flock will be organized weekly and monthly and visualized using line graphs. By analyzing these line graphs of average live weight change of the entire flock, we can determine the weight change trends of the whole flock, identifying their growth and market periods. Furthermore, by plotting each poultry's live weight change curve and comparing it with the poultry flock's average weight change, we can identify and remove poultry with abnormal weights as early as possible. This approach, which involves controlling feed delivery at different stages and culling underweight or overweight poultry, can reduce feeding costs while increasing the farm's economic efficiency.

To investigate poultry distribution patterns, we organize the poultry location information collected in S4 by time. Subsequently, the duration poultry spend in different areas is presented by using a stacked bar chart to understand their preferences and activity patterns within various zones.

Next, by creating time-area distribution maps, we will analyze the poultry's location distribution patterns at different times and conduct an in-depth analysis by combining this with their weight changes. By comparing the frequency of poultry activity in different areas with their weight gain, we can predict weight change trends under various environmental conditions, thus improving the accuracy of weight management. Simultaneously, the system will continuously monitor each poultry's location information. Using big data analytics, we will deeply mine their long-term activity patterns based on this location data. This will allow for further research into how poultry activity and weight change in response to different environmental factors, thereby providing data support for predicting poultry weight trends and optimizing scientific management

To provide users with a more intuitive view of individual poultry growth performance, the system platform offers a data dashboard module, a growth performance module, a behavior analysis module, a data early warning module, and an operation management module. The technology stack for this system utilizes the Vue3 framework and Alibaba's open-source components for front-end styling, while the back-end structure is built by using the Java SpringBoot framework, Redis middleware, and the MyBatisPlus framework.

The data dashboard module provides users with a page to view data information about the poultry flock. This includes on-site installation diagrams of the equipment, live footage from site cameras, the number of devices, and summarized data on the flock's behavioral characteristics, growth performance, and equipment anomaly alerts.

The growth performance module provides the user with a page to view the growth performance of individual poultry, displaying the poultry's current weight, yesterday's weight, last month's weight, and initial weight. This allows the user to observe the growth of poultry over different time spans, offering a reference for judging the future growth trends of poultry.

The behavior analysis module provides the user with a page to view the behavioral patterns of poultry over different time periods. This page shows the various behaviors poultry exhibit at different times, helping the user accurately locate poultry distribution and understand the behavioral habits of the poultry group. By relying on this data, more scientific poultry management strategies can be implemented.

The alarm information module provides the user with an alarm information page that alerts the user to issues with device types, poultry, and other current problems, allowing the user to promptly identify and address any issues with equipment or poultry.

The operation management module provides the user with a page for threshold management and equipment management. The user can adjust various parameter types in threshold management to control parameters such as the normal weight range of poultry, supporting the user in adjusting behavioral parameters based on actual production scenarios. The equipment management page displays all device types deployed by the user in the farm, allowing clear viewing, management, and other operations for each device.

The management system and user interaction platform provided by this measuring device allow users to clearly view parameters such as the growth performance and behavioral characteristics of poultry in the farm, enabling high-precision real-time monitoring of poultry, which has significant practical value.

The invention is described with reference to the flow diagrams and/or block diagrams of the method, apparatus (system), and computer program product according to the embodiments of the invention. It should be understood that each process and/or block in the flow diagram and/or block diagram, and the combination of processes and/or blocks in the flow diagram and/or block diagram, can be implemented by computer program instructions. These computer program instructions can be provided to a general-purpose computer, a special-purpose computer, an embedded processor, or another programmable data processing device to produce a machine, such that the instructions executed by the processor of the computer or other programmable data processing device produce a device for performing the functions specified in one or more processes and/or blocks in the flow diagram and/or block diagram.

These computer program instructions may also be stored in a computer-readable storage medium that is capable of guiding the computer or other programmable data processing device to operate in a specific manner, so that the instructions stored in the computer-readable storage medium produce an article of manufacture that includes the instructions. The article of manufacture implements the functions specified in one or more processes and/or blocks in the flow diagram and/or block diagram.

These computer program instructions may also be loaded into a computer or other programmable data processing device, causing the computer or other programmable device to execute a series of operational steps to produce a computer-implemented process, whereby the instructions executed on the computer or other programmable device provide the steps for performing the functions specified in one or more processes and/or blocks in the flow diagram and/or block diagram.

The invention uses specific embodiments to illustrate the principles and implementation methods of the invention. The above embodiments are only used to help understand the method and core ideas of the invention. At the same time, for those skilled in the art, there will be changes in the specific implementation methods and application scopes based on the ideas of the invention. In summary, the contents of this specification should not be understood as limiting the invention.

Those skilled in the art will realize that the embodiments described herein are intended to help readers understand the principles of the invention, and should be understood that the protection scope of the invention is not limited to such specific statements and embodiments. Those skilled in the art can make various other specific variations and combinations based on the technical inspirations provided by the invention without departing from the essence of the invention, and these variations and combinations are still within the protection scope of the invention.

1. A multi-channel walk-in floor-reared poultry growth performance measurement method, comprising the following steps:
S1: constructing a multi-channel walk-in floor-reared poultry growth performance measurement system, comprising a control processing module, a position information module, a behavior analysis module, a weight calculation module, and a result storage module,
the position information module unidirectionally transmits poultry position information to the control processing module, the control processing module processes data to obtain position information of the poultry; the control processing module then sends an instruction to activate the weight calculation module, the weight calculation module collects dynamic weight of the poultry passing through the channel and calculates true weight of the poultry before returning it to the control processing module; the control processing module obtains behavior type of the poultry from the collected information via the behavior analysis module, finally, based on the obtained dynamic weight and behavior characteristics of the poultry, predicted weight of the poultry is analyzed, and the data is transmitted to the result storage module for saving;
building a multi-channel walk-in floor-reared poultry growth performance measurement device, comprising a ramp, an RFID reader/writer, a channel platform, a bottom resistive strain gauge sensor, channel railings, an RFID reader/writer, a system host, a multi-function weighing and force measuring instrument, a system display screen, a console-type operating enclosure platform, and channel baffles;
S2: when the poultry steps onto the channel platform, the weight calculation module activates, at this point, the resistive strain gauge sensor at a bottom of the channel platform begins to operate, continuously reading weight information of the poultry, the weight reading process is completed when the weight returns below a threshold;
S3: calculating the true weight of the poultry from the collected weight information, the specific method is as follows: S31: calculating expected value of overall dynamic weight data from the continuously read poultry weight information obtained in S2;
S32: determining if the dynamic weight is stable based on the expected value calculated in S31, if not stable, filtering out abnormally fluctuating body weight values by using a median filtering algorithm;
S33: performing mean filtering on median-filtered weight values to reduce overall dynamic weight fluctuations;
S34: based on processing results from S33, inputting processed data into the weight calculation module for weight calculation and outputting weight calculation results;
S35: dividing the weight calculation results output from S34 into multiple data slices, and calculating slope, intercept, and root mean square error for each group of data;
S36: repeating S31-S35 until there are no further data groups, then the weight calculation is completed, and an optimal predicted weight is output as the true weight of the poultry;
S4: calculating distribution locations of the poultry based on read identity information of the poultry.

2. The multi-channel walk-in floor-reared poultry growth performance measurement method of claim 1, wherein a calculation method for the expected value in S32 is as follows:
$$E = \frac{1}{n - 1} {{\sum }_{i = 1}}^{n - 1} \vert {w}_{i + 1} - {w}_{i} \vert$$
wherein E represents the expected value of dynamic weight curve, n represents the number of weight data collected, wᵢ₊₁ and wᵢ respectively represent true weight values at time i+1 and time i.

3. The multi-channel walk-in floor-reared poultry growth performance measurement method of claim 1, wherein a specific method for the median filtering in S32 is as follows:
$$\text{?} = median ( {w}_{i - m} , {w}_{i - m + 1} , … , {w}_{i + m} )$$
wherein i represents time, [symbol] represents predicted weight value, wᵢ represents true weight value, m represents a window size of the median filtering, median ( ) represents a calculation of median for a set of data.

4. The multi-channel walk-in floor-reared poultry growth performance measurement method of claim 1, wherein a specific method for the mean filtering in S33 is as follows:
$${\hat{w}}_{i} = \frac{1}{2 m + 1} {\sum }_{k = i - m}^{i + m} {w}_{k}$$
wherein i represents time, [symbol] represents predicted weight value, k represents a position of weight data within the filtering window, wₖ represents weight value before mean filtering, m is a window size of the mean filtering.

5. The multi-channel walk-in floor-reared poultry growth performance measurement method of claim 1, wherein a specific method for the root mean square error in S35 is as follows:
$$RMSE = \sqrt{\frac{1}{M} {\sum }_{i = 1}^{M} {( {\hat{w}}_{i} - {w}_{i} )}^{2}}$$
wherein i represents time, [symbol] represents predicted weight value, wᵢ represents true weight value, M represents the number of samples used to calculate the root mean square error.

6. The multi-channel walk-in floor-reared poultry growth performance measurement method of claim 1, wherein S4 specifically comprises the following steps:
S41: after the poultry passes through the channel, information collected by the RFID reader/writer is transmitted to the position information module, the information is then sorted by the order of collection time;
S42: after preprocessing the data, RFID antenna numbers from which signals were read before and after the poultry passed through the channel are compared to determine if the poultry has indeed gone through that channel;
S43: based on the RFID antenna numbers where identity information was read (before and after), direction of entry/exit of the poultry is determined; according to the currently read RFID antenna position of the poultry and the entry/exit direction, current location information of the poultry is determined;
S44: by comparing relevant data (collected time, weight, and reading position) during different time periods, a distribution pattern of the poultry is obtained.
